(19) United States
(12) Patent Application Publication
(10) Pub. No.: US 2013/0098566 A1
(43) Pub. Date: Apr. 25, 2013

(54) Retractable Screen Apparatus, System, and Method

(71) Applicant: Louis Horvath, Northpost, AL (US)

(72) Inventor: Louis Horvath, Northpost, AL (US)

(21) Appl. No.: 13/280,667

(22) Filed: Oct. 25, 2011

(51) Int. Cl. E06B 9/54; E06B 9/68; B21J 15/02; E06B 9/50

(52) U.S. Cl. 160/273.1; 29/525.06

(57) ABSTRACT

Retractable protective screen devices and related systems comprising means for retention of a screen in an intended configuration under conditions of wind and/or other separating forces are disclosed. In some embodiments, a screen carries a plurality of spaced-apart rivets, each overlying a corresponding, spaced-apart substrate material, disposed approximately in-line and adjacent a margin or edge of the screen. A guide channel is configured to be affixed to a door, window, or other frame. The guide channel is further configured with a cavity and slot to provide passage of the rivets and screen, respectively, therethrough. With such configuration, the screen is constrained in its intended position against wind and/or other separating forces. Further advantageously, the screen is maintained in its preferred configuration throughout its entire range of travel, and is constrained throughout that range of travel against wind and/or other separating forces.

### TECHNICAL FIELD

The present invention relates, generally, to retractable environmental, insect, and protective screens; and, more particularly, to retractable environmental, insect, and protective screen devices and related systems that provide novel and useful means for retention of a screen in an intended configuration under conditions of wind and/or other separating forces.

### BACKGROUND

Fixed frame screens have been used for seasonal placement over windows. Typically, such fixed frame screens have been used to prevent insects from entering into a home while the associated windows are open. Such fixed frame screens further may be appropriate to reduce the amount and nature of wind-carried contaminants, debris, tree leaves, and the like, entering a home. Fixed frame screens are either left in place permanently or are taken out in the off-season for storage in an attic, basement, or the like. Fixed frame screens typically present perpetual maintenance problems because they are frail.

In contrast, a retractable screen system is housed in a cassette that is permanently mounted to a portion of either a door or window frame and, typically, does not need to be removed for storage. When not in use, the screen simply retracts into the permanently mounted cassette. Retractable screens have also increased in popularity for use as sun screens.

Known retractable screen systems, however, do not provide means sufficient to keep the screen in position for the above-described, intended purposes under conditions of high wind velocities, impact forces, or the like. The few present systems that attempt to solve this problem provide a series of rivets or snaps that are affixed to the screen and which travel within a frame to resist wind forces. Continuous strips of thin, flexible material are affixed near the edge of the screen. This material acts both as reinforcement and substrate for the rivets or snaps. Disadvantageously, such strips of material cause the edges of the screen to bulge during windup. This bulging causes mechanical problems that must be overcome in the design of the retraction and spooling mechanisms in order to cope with the bulging. Additionally, such bulging may cause telescoping of the screen from the retraction tube, as well as unsightly and problematic waving within and across the screen, areas of non-uniform tension, tangling of the screen in the retraction, deployment, and frame mechanisms, and associated stresses, resulting in damage to screen and apparatus. If the screen suffers any of these problems, or is blown, forced, or knocked out of position, it obviously cannot operate as intended. Once out of position, it may not properly return to its intended, useful configuration, and may, thereafter, fail to fully protect against entry of insects and other environmental contaminants into the home, and/or fail to fully provide the intended sun screen benefit.

Accordingly, it would be useful and beneficial to provide retractable protective screen devices and related systems that comprise new, novel, and nonobvious means for retention of a screen in an intended configuration under conditions of wind and/or other separating forces. It is to the disclosure of such retractable protective screen devices and related systems that the following is directed.

### SUMMARY

In general, the present disclosure is directed to retractable protective screen devices and related systems comprising means for retention of a screen in an intended configuration under conditions of wind and/or other separating forces. Specifically, and pursuant to a preferred embodiment of the present disclosure, a screen carries a plurality of spaced-apart rivets, or other such functionally equivalent elements, each overlying a corresponding, spaced-apart substrate material, disposed approximately in-line and adjacent a margin or edge of the screen. A guide channel is configured to be affixed to a door, window, or other frame. The guide channel is further configured with a cavity and slot to provide passage of the rivets and screen, respectively, therethrough. With such configuration, the screen is constrained in its intended position against wind and/or other separating forces. Further advantageously the screen is maintained in its preferred configuration throughout its entire range of travel, and is constrained throughout that range of travel against wind and/or other separating forces.

In some embodiments, brushes may be utilized in association with the guide channel and screen in order to optimally position the screen, and to provide appropriate tension within, and lateral flatness across, the screen. In some embodiments, the need for a cassette, with its many associated parts, advantageously may be avoided.

These and other features and advantages of the various embodiments of retractable protective screen devices and related systems comprising means for retention of a screen in an intended configuration under conditions of wind and/or other separating forces, as set forth within the present disclosure, will become more apparent to those of ordinary skill in the art after reading the following Detailed Description of Illustrative Embodiments and the Claims in light of the accompanying drawing Figures.

### BRIEF DESCRIPTION OF THE DRAWINGS

Accordingly, the within disclosure will be best understood through consideration of, and with reference to, the following drawing Figures, viewed in conjunction with the Detailed Description of Illustrative Embodiments referring thereto, in which like reference numbers throughout the various Figures designate like structure, and in which:

FIG. 1 illustrates a side view of one embodiment of a retractable protective screen device and system comprising means for retention of a screen in an intended configuration under conditions of wind and/or other separating forces;

FIG. 2 illustrates a top view of one embodiment of a guide channel according to FIG. 1 for a use in association with a retractable protective screen device and system comprising means for retention of a screen in an intended configuration under conditions of wind and/or other separating forces;

FIG. 3 illustrates a side view of one embodiment of a guide channel according to FIG. 1 for a use in association with a retractable protective screen device and system comprising means for retention of a screen in an intended configuration under conditions of wind and/or other separating forces;

FIG. 4 illustrates a top, partial sectional view of one embodiment of a guide channel according to FIG. 1 for a use in association with a retractable protective screen device and system comprising means for retention of a screen in an intended configuration under conditions of wind and/or other separating forces, and further illustrating an arrangement of rivet and screen elements in association with the guide channel;

FIG. 5 illustrates a top view of another embodiment of a guide channel for a use in association with a retractable protective screen device and system comprising means for retention of a screen in an intended configuration under conditions of wind and/or other separating forces, and further illustrating an arrangement of brushes which may be utilized in association with the guide channel and screen;

FIG. 6 illustrates a top, partial sectional view of the embodiment of guide channel according to FIG. 5 for a use in association with a retractable protective screen device and system comprising means for retention of a screen in an intended configuration under conditions of wind and/or other separating forces, and further illustrating an arrangement of rivet and screen elements in association with the guide channel.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF ILLUSTRATIVE EMBODIMENTS

In describing the several embodiments illustrated in the Figures, specific terminology is employed for the sake of clarity. The invention, however, is not intended to be limited to the specific terminology so selected, and it is to be understood that each specific element includes all technical equivalents that operate in a similar manner to accomplish a similar purpose. Additionally, in the Figures, like reference numerals shall be used to designate corresponding parts throughout the several Figures.

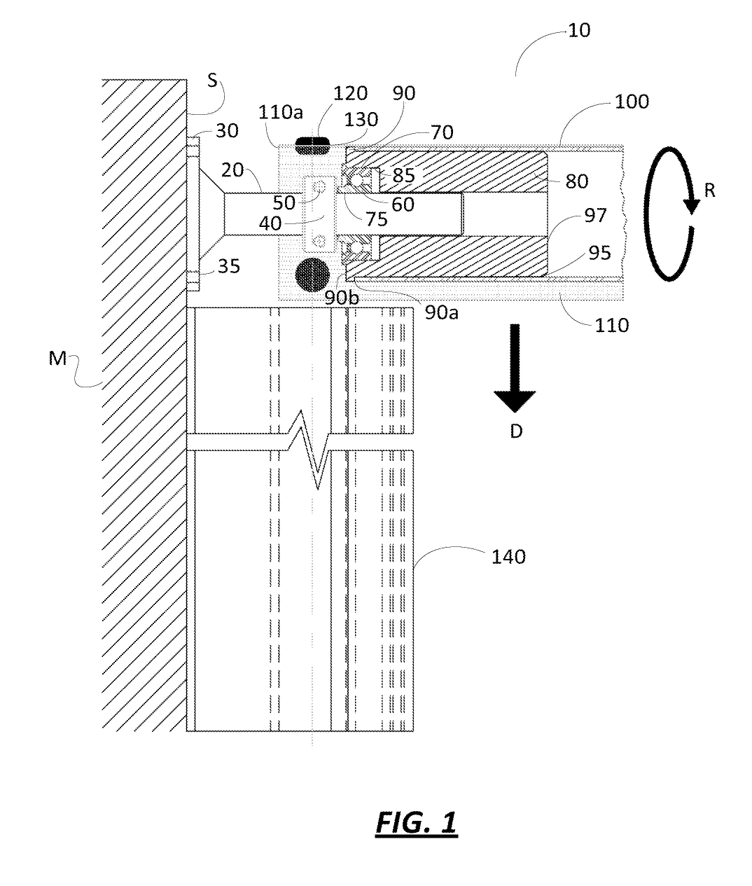

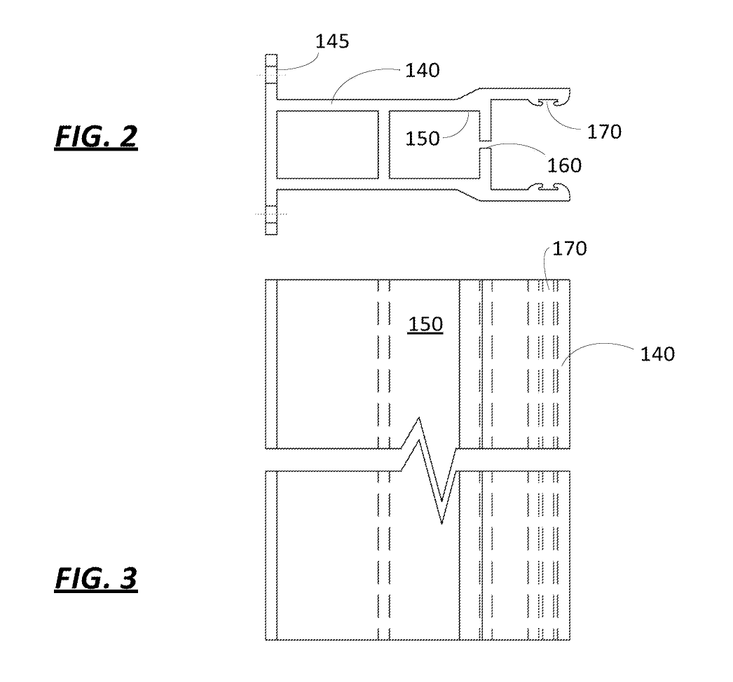

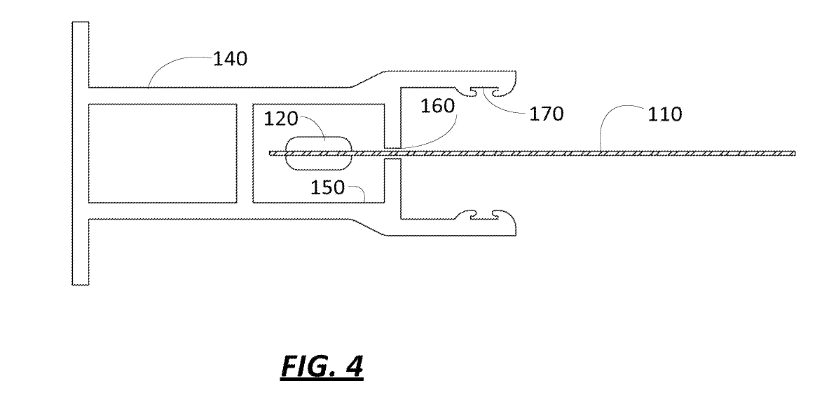

Illustrated in FIGS. 1-4 is a retractable protective screen device and system comprising means for retention of a screen in an intended configuration under conditions of wind and/or other separating forces. In some embodiments, a construction such as has been disclosed in U.S. patent application Ser. No. 11/300,734, filed Dec. 15, 2005, now U.S. Pat. No. 8,016,013, issued on Sep. 13, 2011 to the present inventor, and which is hereby incorporated by reference as though set forth herein in its entirety, may be utilized in association with the present subject matter, although other constructions, without limitation, may also be employed.

As may be seen with reference to FIG. 1, apparatus 10 includes idler shaft 20 associated with bracket 30. Bracket 30 is affixed by screws, bolts, or other fastening means (not shown) passing through openings 35 and into surface S. Openings 35 may be holes, slots, or the like, as known in the art. Surface S may be a door, window, or other frame. Surface S is constructed from preferably structural material M useful for carrying and supporting apparatus 10. In some embodiments, material M may be formed from wood, metal, composite materials, and/or the like, and/or combinations thereof.

Affixed to shaft 20 is collar 40. In some embodiments, collar 40 is a two-piece set. In some embodiments, collar 40 may be approximately ⅝ inches in width. Collar 40 may be affixed to shaft 20 by use of one or more set screw 50.

Shaft 20 carries bearing 60, which has outside diameter 70 and inside diameter 75. In some embodiments, bearing 60 may be a ball bearing of approximately ⅝ inches in width. Shaft 20 typically is formed with tolerance enabling it to carry inside diameter 75 of bearing 60 in a slip fit configuration.

Outside diameter 70 of bearing 60 is fit into tube adapter 80. Outside diameter 70 of bearing 60 typically is formed with tolerance enabling it to fit into recess 85 of tube adapter 80 in a press fit configuration. Bearing 60 is disposed to abut collar 40 in order to limit axial movement of the assembly, as is well-known in the art. Any excess length of shaft 20 may pass through recess 85 of tube adapter 80 and into a central portion of tube adapter 80, as shown in FIG. 1.

Tube adapter 80 has flange 90, outside diameter 95, and distal end 97. Outside diameter 95 of tube adapter 80 is configured to fit into and carry tube 100. In some embodiments, outside diameter 95 of tube adapter 80 is configured to carry tube 100 utilizing a press fit configuration. Such a press fit configuration is achieved by forming outside diameter 95 of tube adapter 80 so that it tapers approximately 1/64 inches from inside 90a of flange 90 to distal end 97. In some embodiments, tube 100 is formed of stainless steel; however, any material appropriate to the use and application of apparatus 10 may be utilized. In some embodiments, tube 100 has an outside diameter of approximately 2 inches.

Tube 100 is configured to carry screen 110. Screen 110 is formed of any suitable mesh-like material. In some embodiments, screen 110 is formed from material such as vinyl, thermoplastic, fiberglass, stainless steel, composites, and/or the like, and may carry one or more coatings or finishes suitable for the intended application and environment in which apparatus 10 will be used. In some embodiments, and for reasons that will be discussed in greater detail hereinbelow, screen 110 is configured to overhang outside 90b of flange 90 by approximately 1 inch.

Screen 110 carries a plurality of spaced-apart rivets 120, or other such functionally equivalent elements, disposed approximately in-line and adjacent margin or edge 110a of screen 110. In some embodiments, the center of each rivet 120 is set inside edge 110a of screen 110 by approximately ½ inch. In some embodiments, each rivet 120 is spaced apart from another rivet 120 by approximately 9 inches. In some embodiments, rivets 120 are formed of plastic, rubber, vinyl, stainless steel, composites, and/or the like, and may carry one or more coatings or finishes suitable for the intended application and environment in which apparatus 10 will be used.

In some embodiments, each rivet 120 is affixed to screen 110 according to a process that may include one or more of the following particulars. In each location on screen 110 wherein a rivet 120 will be affixed, substrate material 130 is applied to screen 110. Substrate material 130 may be a flowable material that fills any voids between strands of material forming screen 110. In some embodiments, substrate material 130 may be a quick set material, such as hot glue material, or the like, applied using conventional processes and equipment for application of such material. Preferably, substrate material 130 is applied to form a spot of material that is approximately ⅝-¾ inches in diameter. In some embodiments, each rivet 120 may comprise a male, piercing portion and a female, receiving portion. In such embodiments, the male, piercing portion is inserted through substrate material 130 and affixed into female, receiving portion. In some embodiments, the male, piercing portion may be a threaded male element and the female, receiving portion may be a threaded female element. In some embodiments, in order to aid in affixing rivet 120, a hole or other appropriate opening may be pre-formed through substrate material 130.

When firmly captured in this manner, rivet 120 is carried and supported by substrate material 130 interspersed within strands of material forming screen 110. Substrate material 130 reduces the chance that rivet 120 will tear or damage screen 110 during use. It also serves to maintain the position of rivet 120 upon screen 110, and provides a substantial material against which rivet 120 may be compressed in order to reduce the chance of loosening, slipping, and/or the like of rivet 120.

Returning to FIG. 1, and with further reference to FIG. 2, guide channel 140 is configured to be affixed to surface S by screws, bolts, or other fastening means (not shown) passing through openings 145 and into surface S. Openings 145 may be holes, slots, or the like, as known in the art. In some embodiments, guide channel 140 is formed of plastic, rubber, Plexiglas, fiberglass, polyvinyl chloride, vinyl, aluminum, stainless steel, composites, and/or the like, and may carry one or more coatings or finishes suitable for the intended application and environment in which apparatus 10 will be used.

As can be seen with reference to FIGS. 2-4, guide channel 140 is further configured with cavity 150 and slot 160 in order to provide passage of rivets 120 and screen 110, respectively, therethrough. In some embodiments, guide channel 140 may be further configured with slots 170 for purposes that will be set forth in further detail hereinbelow.

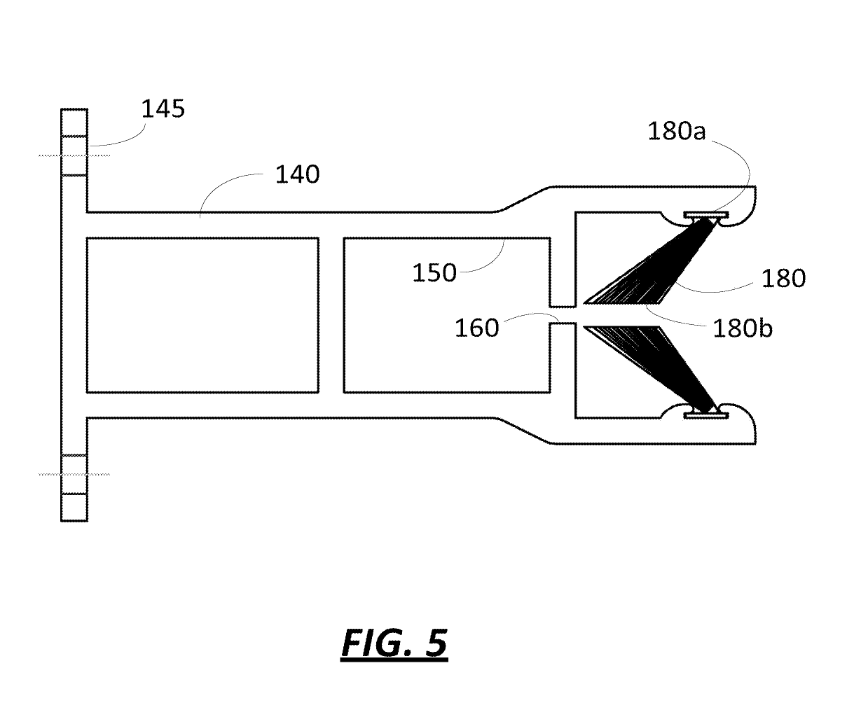

As may be seen with reference to FIG. 4, for use of apparatus 10, rivets 120 are inserted into cavity 150, and screen 110 is passed through slot 160, of guide channel 140. Best seen with continuing reference to FIG. 1, as tube 100 is rotated through any appropriate number of revolutions R sufficient to partially or wholly deploy or retract screen 110 through distance D, screen 110 will lower or raise, depending upon the direction of rotation of tube 100, guided by rivets 120 traveling inside guide channel 140.

With such configuration, screen 110 is constrained by rivets 120 captured within cavity 150 of guide channel 140; and is, thus, maintained in its intended configuration against wind and/or other separating forces. Further advantageously with such configuration, and as now may be seen, screen 110 is maintained in such preferred position and configuration throughout its entire range of travel, and is, thus, constrained throughout that range of travel against wind and/or other separating forces.

As will now be apparent to those of ordinary skill in the art, screen 110 is intended to be spooled upon, and unspooled from, tube 100. As screen 110 is spooled upon tube 100, and due to the thickness of rivets 120 and substrate material 130, the wrap builds and the end of screen 110 carrying rivets 120 tends to flare in thickness. Unlike known prior art devices, because the end of screen 110 is left unconstrained, and because the end of screen 110 extends beyond outside 90b of flange 90, in some embodiments by approximately 1 inch, this tendency of screen 110 to build and flare is not deleterious to operation of apparatus 10. Rather, since the end is unconstrained, there is sufficient space for screen 110 carrying rivets 120 to naturally deflect, advantageously avoiding stresses and resulting damage to screen and apparatus.

Importantly, with this construction, the problems observed within the known prior art systems are substantially avoided. Because the end of the screen is unconstrained and extends beyond the spooling apparatus, this bulging effect is accommodated. Thus, there are no mechanical problems that must be overcome in the design of the retraction and spooling mechanisms in order to cope with bulging due to the rivets. Additionally, because the bulging due to the rivets is so accommodated, there is no telescoping of the screen from the spooling mechanism. Nor is there unsightly or problematic waving within and across the screen. Nor are there areas of non-uniform tension in the screen. Nor is there tangling of the screen in the retraction, deployment, and frame mechanisms, nor associated stresses within the screen. Thus, the factors that were believed to cause damage to screen and/or apparatus of prior art systems may be avoided with the present construction.

Furthermore, because prior art systems have tended to decrease the size of the rivets utilized in order to reduce the above-described, deleterious effects of rivet-caused bulging, such systems have been constrained in their ability to resist extreme wind forces. Up to now, and with consideration to such prior art systems, wind velocities of approximately 20 miles per hour or less have led to damage of the screen, malfunction of the associated apparatus, jamming of the screen within the associated apparatus, and/or other failure conditions.

Because the present construction accommodates bulging of the screen caused by the rivets, rivet sizes may be selected and optimized for effectiveness against wind loads, even if such would result in increased rivet size. Thus, by way of comparison and contrast between the instant apparatus and such prior art, systems constructed according to the present disclosure have been observed to operate successfully at wind velocities between approximately 50-60 miles per hour, and without the deleterious effects observed within prior art devices.

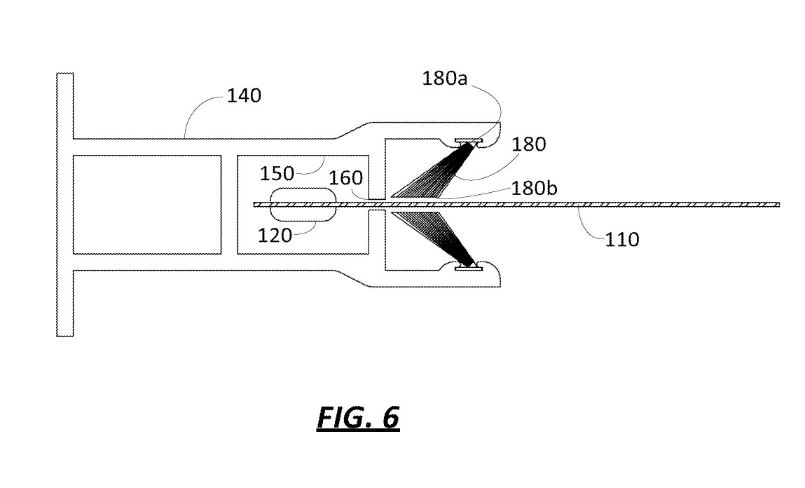

Turning now to the embodiment of FIGS. 5-6, guide channel 140 may be further configured with slots 170 for purposes that will now be discussed. As may be seen in FIGS. 5-6, brushes 180 may be utilized in association with guide channel 140 and screen 110. Brushes 180 may be disposed in slots 170 by means wherein brushes 180 are provided with ends 180a configured to fit within and cooperatively engage slots 170. So configured, ends 180b of brushes 180 optimally position screen 110, and provide, appropriate tension within, and lateral flatness across, screen 110. In some embodiments, brushes 180 are slanted from slots 170 and toward slot 160 of guide channel 140, as shown in FIGS. 5 and 6.

In general, it is appreciated that any embodiment of apparatus 10 described above can advantageously include a cassette housing, not shown but well known in the art, into which screen 110 can retract. Those of ordinary skill in the art will further appreciate that the cassette housing can include a spring-loaded roll bar onto which screen 110 can retract as needed. It is understood that there are a variety of additional or other devices that can act to retract screen 110 into a cassette housing. In some embodiments, however, the need for a cassette, with its many associated parts, advantageously may be avoided. Accordingly, in some such embodiments, apparatus 10 may be powered by means such as electrical motor or other form of motive force to deploy and/or retract screen 110, including but not limited to a hand crank, chain pull, pneumatic motor, hydraulic motor, and/or the like.

Having thus described exemplary embodiments of the subject matter of the present disclosure, it is noted that the within disclosures are exemplary only and that various other alternatives, adaptations, and modifications may be made within the scope and spirit of the present invention. For example, while the disclosure set forth hereinabove has been provided with reference to applications such as windows and doors, the subject matter could be extended to use in association with swimming pool coverings, sun porches, garages, open sided buildings, or the like, without limitation.

Furthermore, depending upon performance requirements and associated engineering design criteria, rivets, or suitable substitute elements, may be applied to the screen adjacent one edge, either edge, or both edges.

In some embodiments, a plurality of rows of rivets, or suitable substitute elements, may operate within a corresponding plurality of cavities formed in a channel guide. In some such embodiments, the rivets may be offset from one another in order to enhance or supplement performance criteria.

In some embodiments, a sheetlike material of cloth, plastic, fabric, leather, fiberglass, or any other material, without limitation, may be used in lieu of screen material for such purposes as to completely block or to reduce airflow, light, sound, dust, environmental irritants, and/or the like, without limitation.

Accordingly, the present subject matter is not limited to the specific embodiments as illustrated herein, but is only limited by the following claims.

What is claimed:

1. A protective apparatus for affixation to a surface, the protective apparatus comprising:
a sheet-like material, said sheet-like material carried by a rotatable member, said rotatable member carried by structure configured to be affixed to the surface;
a guide channel configured to be affixed to the surface;
means affixed to said sheet-like material to constrain an edge of said sheet-like material within said guide channel; and
means for deploying and retracting said sheet-like material;
wherein said sheet-like material is constrained against action of wind and/or other forces.

2. The apparatus of claim 1 wherein said sheet-like material comprises a mesh-like screen.

3. The apparatus of claim 1 wherein said guide channel further comprises a cavity and a slotted opening.

4. The apparatus of claim 1 wherein said means affixed to said sheet-like material comprise a rivet.

5. The apparatus of claim 1 wherein said means affixed to said sheet-like material comprise a plurality of rivets.

6. The apparatus of claim 5 wherein said plurality of rivets are spaced-apart and are disposed approximately in-line and adjacent a margin or edge of said sheet-like material.

7. The apparatus of claim 1 further comprising a discontinuous substrate material in association with each of said sheet-like material and said means affixed to said sheet-like material.

8. The apparatus of claim 1 wherein said means for deploying and retracting said sheet-like material comprises a motor.

9. The apparatus of claim 1 wherein said channel guide further comprises one or more brushes.

10. The apparatus of claim 1 wherein an end of said sheet-like material extends beyond a corresponding end of said rotatable member.

11. A retractable screen system for affixation to a surface, the system operable to prevent wind and/or other forces from unduly deflecting the screen, the system comprising:
a mesh-like screen spooled upon a rotatable member, said rotatable member carried by structure configured to be affixed to the surface;
a guide channel comprising a cavity and a slot, said guide channel configured to be affixed to the surface;
substrate material carried by said screen in a plurality of spaced-apart locations adjacent an edge of said screen, said substrate material interspersed at each said location within strands of material forming said screen;
a plurality of rivets, each said rivet affixed to one of said locations carrying said substrate material, said plurality of rivets acting to constrain an edge of said screen within said guide channel; and
means for deploying and retracting said screen.

12. The system of claim 11 wherein said rivets travel within said cavity of said guide channel and wherein said screen travels within said slot of said guide channel.

13. The system of claim 11 wherein said substrate material comprises hot melt glue.

14. The apparatus of claim 11 wherein said channel guide further comprises one or more brushes.

15. The apparatus of claim 11 wherein an end of said sheet-like material extends beyond a corresponding end of said rotatable member.

16. A method for producing a screen for use in association with a retractable screen system, the system operable to prevent wind and/or other forces from unduly deflecting the screen, the method comprising the steps of:
applying a substrate material onto a surface of said screen in a plurality of spaced-apart locations adjacent an edge of said screen, said substrate material interspersed at each said location within strands of material forming said screen;
affixing a plurality of rivets to said screen, each said rivet affixed to one of said locations carrying said substrate material, said plurality of rivets acting to constrain an edge of said screen within a guide channel of said retractable screen system.

17. The method of claim 16 wherein said substrate material comprises hot melt glue.

18. The method of claim 16 wherein said rivet comprises a two part, cooperating construction having a male, piercing portion and a female, receiving portion.

19. The method of claim 18 wherein the male, piercing portion is inserted through said substrate material and affixed into said female, receiving portion.

20. The method of claim 19 wherein a hole or other appropriate opening is pre-formed through said substrate material prior to insertion of said male, piercing portion.
